(19) United States
(12) Patent Application Publication
(10) Pub. No.: US 2016/0016467 A1
(43) Pub. Date: Jan. 21, 2016

(54) STARTING MECHANISM FOR A MOTOR VEHICLE

(71) Applicant: FORD GLOBAL TECHNOLOGIES, LLC, Dearborn, MI (US)

(72) Inventors: Marcel MATHISSEN, Wuerselen NRW (DE); Rainer VOGT, Aachen NRW (DE); Achim LINDNER, Euskirchen (DE)

(21) Appl. No.: 14/804,115

(22) Filed: Jul. 20, 2015

(30) Foreign Application Priority Data
Jul. 21, 2014 (DE) 10 2014 214 099.4

(51) Int. Cl. B60K 28/06

(52) U.S. Cl. CPC B60K 28/063

(57) ABSTRACT

A starting mechanism for a motor vehicle with an ignition mechanism, a programmable ignition key and a detector for alcohol and/or drugs, wherein the ignition mechanism is configured to be started by the ignition key if the detector for alcohol and/or drugs provides a result below a limit value, wherein the programmable ignition key comprises an adjustable identifier that deactivates the detector for alcohol and/or drugs and enables starting of the ignition mechanism.

### CROSS-REFERENCE TO RELATED APPLICATIONS

This application claims foreign priority benefits under 35 U.S.C. §119(a)-(d) to DE 10 2014 214 099.4 filed Jul. 21, 2014, which is hereby incorporated by reference in its entirety.

### TECHNICAL FIELD

The invention relates to a starting mechanism for a motor vehicle with an ignition mechanism, a programmable ignition key and a detector for alcohol and/or drugs, wherein the ignition mechanism is configured to be started by the ignition key if the detector for alcohol and/or drugs provides a result below a limit value.

### BACKGROUND

It is generally known to fit motor vehicles with alcohol and drug detectors in order to prevent the operation thereof by an unfit driver.

For example, EP 1 601 548 B1 thus discloses a starting mechanism for a motor vehicle with a key and a separate external analysis unit, wherein the vehicle will only start with the key if the alcohol or drugs content of the tested specimen lies below a specified limit.

This ensures both that the key is present and also that the alcohol or drug test has a negative result.

A system for starting an automobile is known from DE 60 2004 013 379 T2, wherein the system comprises a first key, with which a door of the automobile can be opened and an ignition means of the automobile can be operated, a second key and an immobilizer of the automobile, which receives a message regarding the presence of the first key, which has been inserted in the ignition, and which prevents starting of the automobile before an OK signal has been received from the second key, wherein the alcohol level of a driver of the automobile is determined by the second key and an OK signal is only transmitted from the second key to the immobilizer if the alcohol level lies below a specified value, wherein the immobilizer enables operation of the ignition in the usual manner by means of the first key if the second key has transmitted the OK signal.

However, there is still a desire for starting mechanisms that allow more flexible operation, for example that allow starting in an emergency or that do not demand an alcohol or drug test from everyone.

### SUMMARY

The object of the invention is therefore to provide an alternative starting mechanism that can be set variably with regard to carrying out an alcohol or drug test.

This object is achieved by the starting mechanism presented in claim 1.

According to the invention, it has been recognized that if the detector for alcohol and/or drugs is deactivated and starting the ignition mechanism is enabled by means of the programmable ignition key, if the programmable ignition key comprises a suitable adjustable readable identifier it is possible to provide at least two types of ignition key, namely ignition keys without restrictions and ignition keys with restrictions.

In other words, there are quasi administrator ignition keys whose users all have rights, i.e., they may also drive without an alcohol or drug test. In addition, there are ignition keys with restricted rights, whose users thus may only drive following a passed alcohol or drug test. Thus, the vehicle cannot be used by a normal user with a restricted ignition key without an alcohol or drug test and without being below the specified limit value in the event of the measurement.

The specification of the rights of the key holder takes place in a database in the control unit in the motor vehicle. A check is thus made as to whether the ignition key has the right to start the ignition mechanism (or not) using the identity of the respective ignition key in the database.

The administrator ignition key can comprise yet more unrestricted rights, such as the control of the log data files, setting the limit values, maximum speeds, etc. In other words, suitable rights, settings, etc. can be stored in the database by means of the administrator ignition key.

However, it is also conceivable that the identifier is adjustable, so that by using the identifier itself, the rights and possibly other settings are stored in the key. This has the disadvantage that the ignition key must be present for the change, but the advantage that the database in the control unit could be dispensed with.

The detector for alcohol and/or drugs can be an external mobile detector. This has the advantage that simple operation is possible during the annual calibration etc. and the entire vehicle does not have to be brought into the workshop. The detector for alcohol and/or drugs can then be connected to the starting mechanism by means of an intelligent mobile telephone. An app is then effectively used, which transmits its data to the vehicle wirelessly, for example by means of Bluetooth, etc. Alternatively, the detector can also be integrated within the vehicle.

Here, drugs include all legal and illegal means that can adversely affect the ability to drive. Drugs within the scope of this invention thus also include legally obtainable medicines if the same adversely affect the ability to drive on their own or in combination with other means and/or factors.

It makes sense for the ignition mechanism to comprise an emergency starting device, which allows bypassing of the limit value or of the entire alcohol or drug test in the event of an emergency. In this way, it is also ensured that the vehicle can be moved in the event of an emergency. For this purpose, depending on the embodiment, it can also be provided that only a low maximum speed is specified for the vehicle (by the administrator ignition key user). This can also take place depending on the measured values from the alcohol or drug test, so that slow driving would be possible despite an emergency and some blood alcohol.

In addition, a suitable message can be sent to the holder of the unrestricted ignition key by SMS, etc. and a suitable log data file entry can be made in order to prevent misuse.

In a further embodiment, a biometric identification unit is provided. Thus, in addition to the ignition key, the identification of the identity of the driver can be carried out. For this purpose, the biometric identification unit can be in the form of an intelligent mobile telephone that is connected to the starting mechanism. Thus, in turn a suitable app can be used.

If the ignition mechanism is configured to be blocked for a specifiable period of time, in the event of a positive alcohol or drug test, the vehicle can be blocked for a specified period of time until it is to be expected that the alcohol or the drugs have lost its or their effect.

### BRIEF DESCRIPTION OF THE DRAWINGS

Further features and details of the invention are revealed in the following description of the figures. In the figures:

FIG. 1 shows a schematic block diagram of an embodiment of the starting mechanism;

FIG. 2 shows a schematic block diagram of a version of the starting mechanism with a mobile telephone;

FIG. 3 shows a schematic block diagram of a further version of the starting mechanism with a mobile telephone and

FIG. 4 shows a schematic flow chart of the process of the alcohol or drug testing and of enabling the vehicle with a starting mechanism according to FIG. 1.

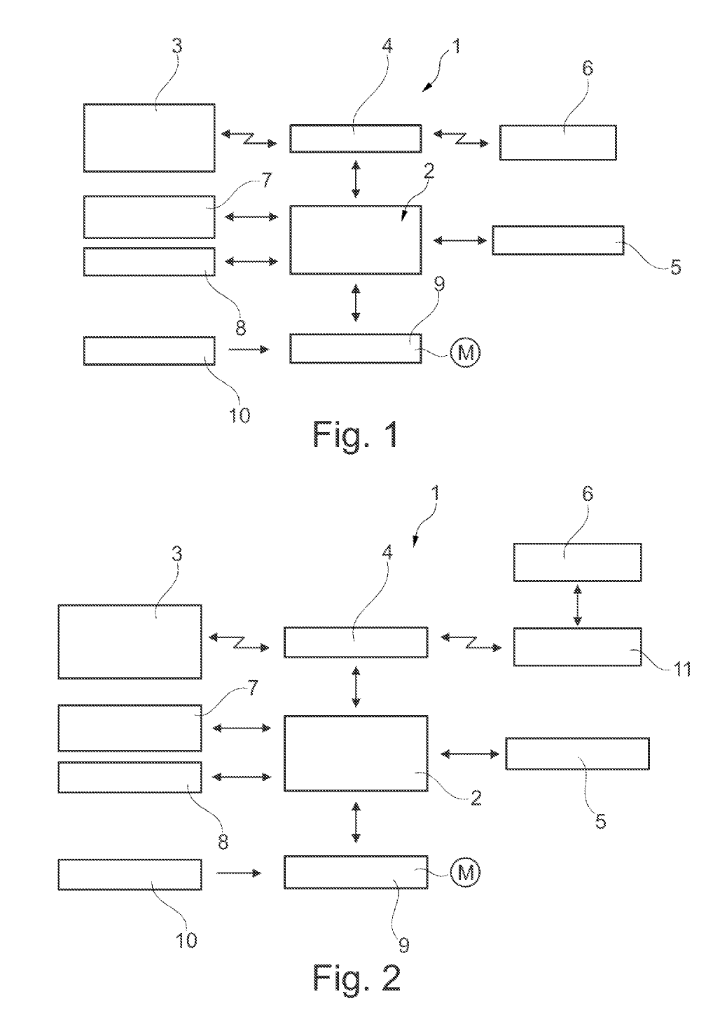

### DETAILED DESCRIPTION

A starting mechanism of an automobile that is referred to as a whole with 1 is illustrated in the figures.

It comprises a central controller 2 that is connected to the engine ignition for starting.

The engine ignition M can be “operated” for this purpose by means of a programmable ignition key 3. The ignition key 3 can be identified and read out wirelessly by means of a transceiver 4, as is usual with modern vehicles.

Using a stored database 5, the controller 2 can test the ignition key or read out its rights.

In addition, a biometric identification unit 7 is provided, which identifies the driver by means of face recognition.

Using a connected display 8, a man-machine interface can be provided and may be operated by means of touch functions.

In addition, a mobile alcohol and drug detector 6 is connected to the controller 2 by means of the transceiver 4 in order to the carry out the appropriate test or to provide measurement values.

A release module 9 that enables or blocks the ignition depending on the result of the ignition key and alcohol or drug testing is also connected to the controller 2.

An emergency system 10 is connected to the release module 9 in parallel in order to be able to bypass the release module 9 despite a negative alcohol or drug test.

The version shown in FIG. 2 differs from the one just described in that the mobile alcohol and drug detector 6 is connected to the transceiver 4 by means of a mobile telephone 11. Thus, the alcohol and drug detector 6 can use the mobile telephone 11 as an interface and accordingly can be of a simple design.

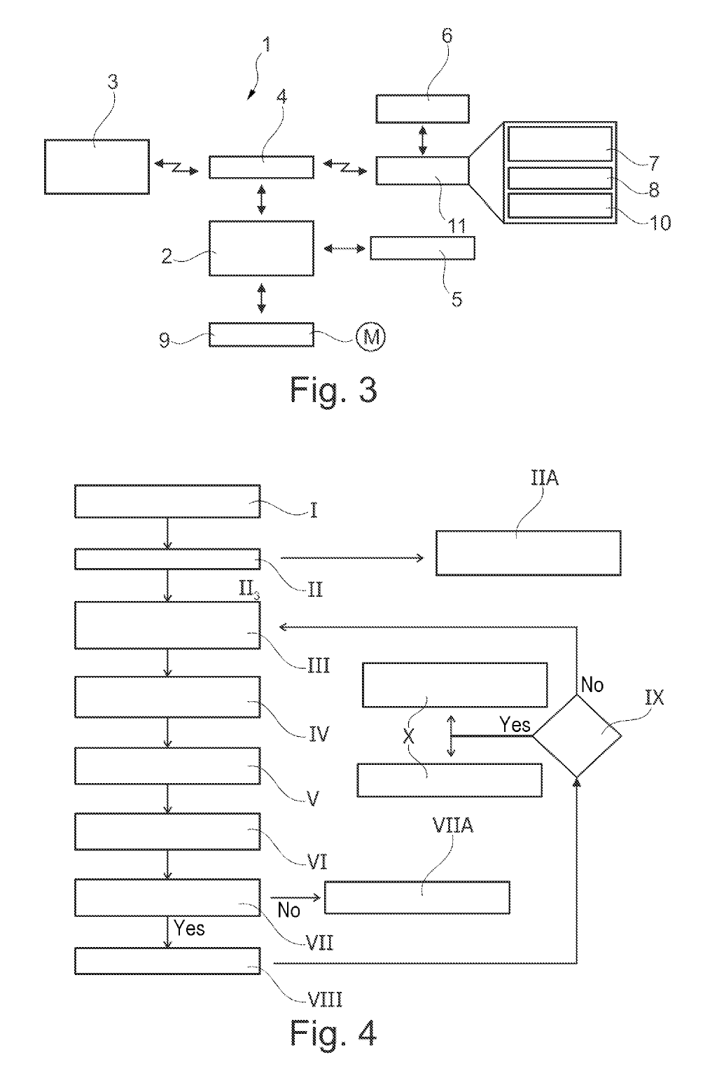

In the further version according to FIG. 3, yet more functions have been integrated within the mobile telephone 11 as a program (app). This now therefore also acts as a biometric identification unit 7 (camera of the mobile telephone) and display 8 (display of the mobile telephone) as well as an emergency system 10.

An exemplary process of an ignition release is explained with reference to FIG. 4.

As the driver approaches the vehicle with ignition key 3, the key 3 is read by the transceiver 4 (step I) and compared in the controller 2 with the database 5 in order to determine the rights (step II).

If it is an ignition key 3 without a restricting identifier, then there are no restrictions (step IIA) and the user can use the vehicle without restrictions (release module 9 is activated).

On the other hand, if it is an ignition key 3 with a restricting identifier (step IIB) the alcohol and drug test is mandatory (step III). Optionally, the identifier can still be checked by means of the biometric identification unit 7.

Accordingly, the engine ignition M is initially not activated by the release module 9 and the mobile telephone 11 is activated (step IV).

This in turn activates the mobile detector 6 (step V), which determines its measurement values and forwards them to the controller 2 by means of the mobile telephone (step VI).

The controller 2 compares the measurement values with specified limit values (step VII) and either enables the ignition by means of the release module 9 (step VIIA) if the measurement value is below the limit value, or continues to block the ignition and starts a countdown (step VIII) if the limit value is exceeded.

A check is then made as to whether the emergency system 10 has been activated. If this is not the case, then the user can carry out the test again in step III only after expiry of the countdown.

On the other hand, if the emergency system 10 has been activated the ignition is enabled in the safety mode with reduced speed and the use of the emergency system is logged (step X).

What is claimed is:

1. A starting mechanism for a motor vehicle comprising:
an ignition mechanism;
a programmable ignition key; and
a detector for at least one of alcohol and drugs,
wherein the ignition mechanism is configured to be started by the programmable ignition key if the detector for the at least one of alcohol and drugs provides a result below a limit value; and
wherein the programmable ignition key includes an adjustable readable identifier that disables the detector for the at least one of alcohol and drugs and enables starting the ignition mechanism.

2. The starting mechanism of claim 1, wherein the detector for the at least one of alcohol and drugs is an external mobile detector.

3. The starting mechanism of claim 2, wherein the detector for the at least one alcohol and drugs is connected to the starting mechanism via an intelligent mobile telephone.

4. The starting mechanism of claim 1, wherein the ignition mechanism comprises an emergency starting device.

5. The starting mechanism of claim 1 further comprising a biometric identification unit that is connected to the starting mechanism.

6. The starting mechanism of claim 5, wherein the biometric identification unit is in the form of an intelligent mobile telephone.

7. The starting mechanism of claim 1, wherein the ignition mechanism is configured to be blocked for a specifiable period of time.

8. A starting mechanism for a motor vehicle comprising:
an ignition mechanism;
a detector for at least one of alcohol and drugs; and
a programmable ignition key including an adjustable readable identifier, the programmable ignition key configured to:
start the ignition mechanism if the detector provides a result below a limit value, and
disable the detector for the at least one of alcohol and drugs and enable starting the ignition mechanism via the adjustable readable identifier.

9. The starting mechanism of claim 8, wherein the detector for the at least one of alcohol and drugs is an external mobile detector.

10. The starting mechanism of claim 9, wherein the detector for the at least one alcohol and drugs is connected to the starting mechanism via an intelligent mobile telephone.

11. The starting mechanism of claim 8, wherein the ignition mechanism comprises an emergency starting device.

12. The starting mechanism of claim 8 further comprising a biometric identification unit that is connected to the starting mechanism.

13. The starting mechanism of claim 12, wherein the biometric identification unit is in the form of an intelligent mobile telephone.

14. The starting mechanism of claim 8, wherein the ignition mechanism is configured to be blocked for a specifiable period of time.

15. A starting mechanism for a motor vehicle comprising:
an ignition mechanism including an emergency starting device;
a programmable ignition key; and
a detector for at least one of alcohol and drugs,
wherein the ignition mechanism is configured to be started by the programmable ignition key if the detector for the at least one of alcohol and drugs provides a result below a limit value; and
wherein the emergency starting device bypasses the limit value and enables the motor vehicle to be moved in the event of an emergency.

16. The starting mechanism of claim 15, wherein the detector for the at least one of alcohol and drugs is an external mobile detector.

17. The starting mechanism of claim 16, wherein the detector for the at least one alcohol and drugs is connected to the starting mechanism via an intelligent mobile telephone.

18. The starting mechanism of claim 15 further comprising a biometric identification unit that is connected to the starting mechanism.

19. The starting mechanism of claim 18, wherein the biometric identification unit is in the form of an intelligent mobile telephone.

20. The starting mechanism of claim 15, wherein the ignition mechanism is configured to be blocked for a specifiable period of time.
